(19) United States
(12) Patent Application Publication
(10) Pub. No.: US 2026/0026515 A1
(43) Pub. Date: Jan. 29, 2026

(54) Meltable Cheese and Sauce Combination Product

(71) Applicant: Paul V. Russo, Port Charlotte, FL (US)

(72) Inventor: Paul V. Russo, Port Charlotte, FL (US)

(21) Appl. No.: 18/828,035

(22) Filed: Sep. 9, 2024

Related U.S. Application Data
(63) Continuation of application No. 18/785,042, filed on Jul. 26, 2024, now abandoned.

(51) Int. Cl. A21D 13/41; A23C 19/16; A23L 29/262; A23L 29/281; A23P 20/20

(52) U.S. Cl. CPC A21D 13/41; A23C 19/16; A23L 29/262; A23L 29/284; A23P 20/20

(57) ABSTRACT

The present invention relates to a meltable cheese and sauce combination product, comprising two slices of cheese with a specially formulated sauce layered between them. The sauce contains gelatin and methylcellulose, which allows it to remain stable when frozen but become loose and distributed throughout the cheese in a controlled manner when heated. This product is designed to provide a convenient way for consumers to add cheese and sauce to various foods, such as breads, English muffins, or cooked proteins.

### PRIORITY

This application is a continuation of U.S. application Ser. No. 18/785,042, filed Jul. 26, 2024, titled Meltable Cheese and Sauce Combination Product.

### FIELD

This invention relates to the field of food and more particularly to a combination food ingredient that provides a convenient way for consumers to add cheese and sauce to various foods.

### BACKGROUND

The history of simplifying pizza preparation can be traced back to the invention of frozen pizza in the 1950s. This marked the beginning of a new era in pizza preparation, as consumers could now enjoy pizza at home without the need for extensive preparation.

In the following decades, new companies began to enter the frozen pizza market. These companies focused on improving the quality and variety of frozen pizzas, making them more appealing to consumers. However, the frozen pizzas still required preparation, such as preheating an oven and waiting for the pizza to cook.

In the 1990s, the introduction of microwave ovens in many households led to the development of microwavable pizza products. These products, such as pizza rolls and pizza pockets, allowed consumers to prepare pizza-like snacks in a matter of minutes. While convenient, these products often sacrificed quality for the sake of speed and ease of preparation. What is needed is a product that allows a consumer, or a restaurant, to quickly make a pizza, without sacrificing quality.

### SUMMARY

The meltable cheese and sauce combination product represents a further step in the evolution of simplified pizza preparation. By combining the cheese and sauce into a single, easy-to-use product, this invention eliminates the need for separate preparation of these key pizza ingredients. The unique formulation of the sauce, which includes gelatin and methylcellulose, allows it to remain stable during frozen storage and distribute evenly when heated, ensuring a consistent and high-quality pizza experience for consumers.

The meltable cheese and sauce combination product is prepared by first formulating a base sauce containing tomatoes, water, gelatin, methylcellulose, salt, citric acid, and spices. Variations of this sauce can include the addition of cooked sausage or pepperoni. The sauce is then deposited and spread evenly onto a slice of low-moisture, part-skim mozzarella cheese. A second slice of cheese is placed on top of the sauce and gently pressed to secure the layers. The product is then packaged and frozen for storage and distribution.

When the consumer is ready to use the product, they place the cheese and sauce combination onto the desired food item, such as an English muffin, pizza crust, buns, bread, or cooked proteins such as a hamburger or chicken, and heat it in the oven or microwave. The sauce, which was stabilized by the combination of gelatin and methylcellulose, melts with the cheese due to the application of heat.

Restated, the sauce, now softened via the heat, liquifies, loosens and distributes throughout the melted cheese. The combination of gelatin and methylcellulose controls the spread of the sauce when heated and prevents any spillage or uneven melting of the sauce across the bread surface. The methylcellulose controls the viscosity of the sauce after disintegration of the gelling agent such as gelatin due to application of heat.

The central sauce disk is solid, but flexible, at room temperature or in a frozen state due to the addition of gelling agents such as gelatin and methylcellulose to a mixture of water, tomatoes, and seasoning. The central sauce disk remains solid, flexible and self-supporting in the frozen state as well as at room temperature. The central sauce disk melts and loses the self-supporting form upon application of heat.

In an example, a combination of gelatin and methyl cellulose is used as the gelling agent to keep the tomato-based sauce firm until heated. The combination of gelatin and methyl cellulose controls viscosity of the tomato-based sauce to ensure an even distribution of sauce through the plurality of holes of the second layer of cheese on application of heat. Because the second surface of the tomato-based sauce is bound to the second layer of cheese, the second surface of the tomato-based sauce passes through the plurality of holes when the food product is heated. The second layer of cheese is cut across the thickness in a preset shape to create the plurality of holes.

This invention provides a convenient and easy-to-use product for consumers seeking to add melted cheese and sauce to various foods without the need for separate preparation of the cheese and sauce components. The unique formulation of the sauce allows it to remain stable during frozen storage but to distribute evenly when heated, ensuring a consistent and satisfying eating experience.

Restated, the invention is:
A central sauce disk, with a slice of cheese on top and a slice of cheese on the bottom;
   The layering of a slice of cheese on each side of the sauce providing structure and reducing flexibility.

By buffering the sauce on each side with cheese, the consumer does not touch the sauce during removal of the item from packaging and application to the bread product. During prototyping, alternative versions of the invention were tested with cheese on a single side. During removal from packaging the consumer would touch both sauce and cheese because the lower face of the sauce disk was exposed. The feedback was that the consumers did not enjoy the feeling of touching the solidified sauce, and that feeling made the resulting product less desirable.

The central sauce disk is solid, but flexible, at room temperature due to the addition of gelatin and methylcellulose to a mixture of water, tomatoes, and seasoning.

During manufacturing the sauce is applied to the cheese and the two are then fused together. As the result of this fusion, the sauce and cheese are later handled as a single item, simplifying the process of assembling the resulting food product. The pH of the sauce is maintained between 4.10 and 4.30.

While the preferred embodiment uses a red sauce, alternative sauces are anticipated, including milk/cream-based sauces, also known as white sauces, or sauces based on a mixture of milk products and tomato products, also known as pink sauces.

The mozzarella cheese is preferably low moisture, part skim mozzarella cheese, formed from pasteurized milk, cheese cultures, salt, and enzymes. Alternative cheeses include cheddar, provolone, and other meltable cheese varieties.

Optionally further included are meats, such as sausage or pepperoni.

When creating a final product that includes meat in the sauce, the ratio of sauce to meat is altered because a sauce with meat is thicker. This greater viscosity results in the meat sauces better resisting oozing out from the cheese layers as compared to a sauce without meat.

Preparation of the sauce includes the following steps:
Adding warm water to a mixer, or adding the water to the mixer and then applying heat;
   The preferred temperature for the water is 200° F. or 93° C.;
Gelatin and methylcellulose are gradually added to the water while mixing, with mixing continued until the gelatin and methylcellulose are fully dissolved;
Then the tomato mixture, salt, seasonings, and citric acid are added to the mixture;
Mixing continues until the uniform texture is reached; and. The mixture is then cooled to 100-120° F. (38°-49° C.) and placed between two layers of cheese.

Table 1 presented below lists the base sauce formula in accordance with an embodiment of the present invention. The base sauce formula includes the following ranges of ingredients:

TABLE 1
Base Sauce Formula

| | Weight percentage (%) totaling |
|---|---|
| Ingredients | to 100% |
| Water | 30-60 |
| Tomatoes | 40-70 |
| Gelatin | 0.5-3 |
| Methylcellulose | 0.2-1 |
| Spices, including salt | 0-3 |
| Citric Acid | 0-1 |

In its preferred embodiment, the base sauce formula includes the following ingredients as described in Table 2 below:

TABLE 2
Preferred Base Sauce Formula

| | Weight percentage (%) totaling |
|---|---|
| Ingredients | to 100% |
| Water | 39.55 |
| Stanislaus 7/11 Ground Unpeeled | 28.40 |
| Tomatoes | |
| Piancone Whole Peeled Plum | 28.40 |
| Tomatoes | |
| Gelatin 250 Bloom Bovine Hide 40 | 2.47 |
| Mesh #14931 | |
| Ticacel ® HV Powder | 0.48 |
| (Methylcellulose) | |
| Salt | 0.37 |
| Black Pepper | 0.15 |
| Garlic Powder | 0.08 |
| Oregano | 0.08 |
| Citric Acid | 0.02 |

In accordance with an embodiment of the present invention, the sauce with meat includes the following ranges of ingredients listed in Table 3 below:

TABLE 3
Sauce with Meat Formula

| | Weight percentage (%) totaling |
|---|---|
| Ingredients | to 100% |
| Base Sauce | 70-85 |
| Pepperoni or Sausage | 15-30 |

In its preferred embodiment, the sauce with sausage includes the following ingredients listed in Table 4 below:

TABLE 4
Preferred Sauce with Sausage Formula

| | Weight percentage (%) totaling |
|---|---|
| Ingredients | to 100% |
| Base Sauce | 70 |
| Burke Cooked Sausage with | 30 |
| Pepperoni Style Seasonings #117978 | |

In its preferred embodiment, the sauce with pepperoni includes the following ingredients listed in Table 5 below:

TABLE 5
Preferred Sauce with Pepperoni

| | Weight percentage (%) totaling |
|---|---|
| Ingredients | to 100% |
| Base Sauce | 83 |
| Burke Ground Pepperoni (Custom | 17 |
| Ingredient) | |

Multiple combinations of the cheese-sauce-cheese disk are within the scope of the invention. A plain NY-style product is prepared as follows:
First and second circular precut mozzarella slices are prepared, with a preferred diameter of 3-½ inches and a preferred thickness of 2.53 mm or 0.099″ thick;
Base sauce is deposited in the center of the first cheese slice and spread to the edges;
The second cheese slice is placed on top of the sauce; and
The resulting combination is packaged and frozen.

In accordance with an embodiment of the present invention, the plain “NY Slice” includes the ranges of ingredients listed in Table 6 below.

TABLE 6
Plain “NY Slice” Formula

| Ingredients | Percentage (%) |
|---|---|
| Grande Cheese Part-Skim | 56 |
| Mozzarella Cheese | |
| Base Sauce | 44 |

Preparation of varieties for the plain “NY Slice” that include meat is similar, with the plain sauce replaced with sauce that includes a meat product, as described further below in Table 7 and Table 8. The meat product may be cooked before adding it to the sauce.

TABLE 7
Sausage Formula

| Ingredients | Percentage (%) |
|---|---|
| Grande Cheese Part-Skim | 53.33 |
| Mozzarella Cheese | |
| Sauce with Sausage | 46.67 |

TABLE 8
Pepperoni Formula

| Ingredients | Percentage (%) |
|---|---|
| Grande Cheese Part-Skim | 50.91 |
| Mozzarella Cheese | |
| Sauce with Pepperoni | 49.09 |

The food product described herein has been tested for its shelf life. The findings indicate that the food product has a primary shelf life and a secondary shelf life. The primary shelf life is of one (1) year in a frozen state. The secondary shelf life is two (2) weeks in a refrigerated state. The primary and secondary shelf life have been validated by the preferred embodiments listed above including but not limited to the plain NY slice with and without meats. The food products' physical and organoleptic qualities were to be evaluated. The study involved microbial testing wherein methods such as Aerobic Plate Count PF-AOAC 990.12, Yeast PF-AOAC 997.02, and Mold PF-AOAC 997.02 were used. The findings from the shelf-life study are presented below in Table 9, Table 10, and Table 11:

TABLE 9
Plain “NY Slice”

| | 1 Year Frozen Accelerated & | | 1 Year Frozen Accelerated & | |
|---|---|---|---|---|
| TEST | Refrigerated 1 Week | | Refrigerated 2 Weeks | |
| APC | 30 | CFU/g | <10 | CFU/g |
| Yeast | 8400 | CFU/g | >15,000 | CFU/g |
| Mold | <10 | CFU/g | 80 | CFU/g |

TABLE 10
Sauce with Pepperoni Formula

| | 1 Year Frozen Accelerated & | | 1 Year Frozen Accelerated & | |
|---|---|---|---|---|
| TEST | Refrigerated 1 Week | | Refrigerated 2 Weeks | |
| APC | 980 | CFU/g | 20 | CFU/g |
| Yeast | >15,000 | CFU/g | >15,000 | CFU/g |
| Mold | <10 | CFU/g | 60 | CFU/g |

TABLE 11
Sauce with Sausage Formula

| | 1 Year Frozen Accelerated & | | 1 Year Frozen Accelerated & | |
|---|---|---|---|---|
| TEST | Refrigerated 1 Week | | Refrigerated 2 Weeks | |
| APC | 10 | CFU/g | <10 | CFU/g |
| Yeast | 40 | CFU/g | >15,000 | CFU/g |
| Mold | <10 | CFU/g | <10 | CFU/g |

In accordance with various embodiments of the present invention, the food product described herein can be cooked using multiple methodologies. For example, for cooking in an oven, a frozen cheese-sauce-cheese disk is placed onto its supporting food structure, then baked for three to five minutes, or two to four minutes for a refrigerated cheese-sauce-cheese disk.

The product can be cooked using multiple methodologies.

For cooking in the oven, a frozen cheese-sauce-cheese disk is placed onto its supporting food structure, then baked for three to five minutes, or two to four minutes for a refrigerated cheese-sauce-cheese disk.

For cooking in the microwave, a frozen cheese-sauce-cheese disk is placed onto its supporting food structure, then baked for one to one-and-one-half minutes, or between thirty seconds and one minute for a refrigerated cheese-sauce-cheese disk.

In the preferred embodiment gelatin and methylcellulose are both incorporated as ingredients because of their differing properties. In alternative embodiments only gelatin is used or only methylcellulose is used. For example, to create a cheese-sauce-cheese disk without animal products, only methylcellulose would be used because it is plant derived, whereas gelatin is animal derived and therefore inappropriate for vegan foods.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a first isometric view of the meltable cheese and sauce combination product.

FIG. 2 illustrates a first view of the meltable cheese and sauce combination product.

FIG. 3 illustrates a second isometric view of the meltable cheese and sauce combination product.

FIG. 4 illustrates a view during assembly of the meltable cheese and sauce combination product.

FIG. 5 illustrates a view showing upper holes, before heating, of the meltable cheese and sauce combination product.

FIG. 6 illustrates a view showing upper holes, after heating, of the meltable cheese and sauce combination product.

FIG. 7 is a flow chart depicting one method of making the meltable cheese and sauce combination product.

### DETAILED DESCRIPTION

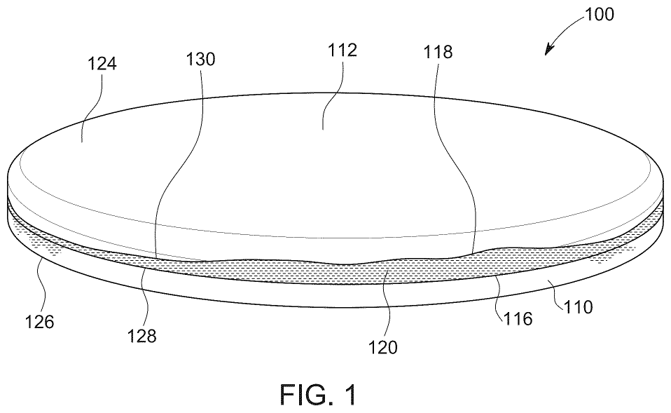

Reference will now be made in detail to the presently preferred embodiments of the invention, examples of which are illustrated in the accompanying drawings. Throughout the following detailed description, the same reference numerals refer to the same elements in all figures. Referring to FIG. 1, a first isometric view of the meltable cheese and sauce combination product is shown.

The meltable cheese and sauce combination product 100 is shown in its assembled state, with first cheese slice 110 and second cheese slice 112 substantially surrounding the sauce mixture 120. The sauce mixture 120 has a lower face 116 and an upper face 118. The first cheese slice 110 is in contact with the lower face 116 of the sauce mixture 120. The second cheese slice 112 is in contact with the upper face 118.

By surrounding the sauce mixture 120, the first cheese slice 110 and the second cheese slice 112 prevent a user from contacting the sauce mixture 120.

Restated, the lower face 116 of the sauce mixture 120 is bound to the first cheese slice 110 until heated and the upper face 118 of the sauce mixture 120 is bound to the second cheese slice 112.

The first cheese slice 110 and the second cheese slice 112 are two of the three main components of the meltable cheese and sauce combination product 100 and they remain firm until heated. Therefore, the first cheese slice 110 and the second cheese slice 112 make the meltable cheese and sauce combination product 100 self-supporting in a frozen state, at room temperature, or until heated. The first cheese slice 110 and the second cheese slice 112 can be manipulated by the user at room temperature without a requirement of handling the sauce. Also, the first cheese slice 110 and the second cheese slice 112 can be directly handled by the user at room temperature. For example, the first cheese slice 110 and the second cheese slice 112 would remain firm at room temperature and would not cause any spillage or textural issues for a user. Therefore, the meltable cheese and sauce combination product 100 does not require any non-edible support system in any of the stages from packaging to its use due to firm support structure provided by the first cheese slice 110 and the second cheese slice 112.

The first layer of cheese such as the first cheese slice 110 includes a top side 128 and a bottom side 126. The top side 128 of the first layer of cheese is in contact with the tomato-based sauce as shown in FIG. 1. The bottom side 126 of the first layer of cheese is in contact with a first bread substrate. For example, the food product 100 may be placed on the first bread substrate such as a pizza base such that the bottom side 126 of the first layer of cheese touching the pizza base. The second layer of cheese includes a top side 124 and a bottom side 130. The top side 124 of the second layer of cheese is optionally in contact with a second bread substrate. The bottom side 130 of the second layer of cheese is in contact with the tomato-based sauce.

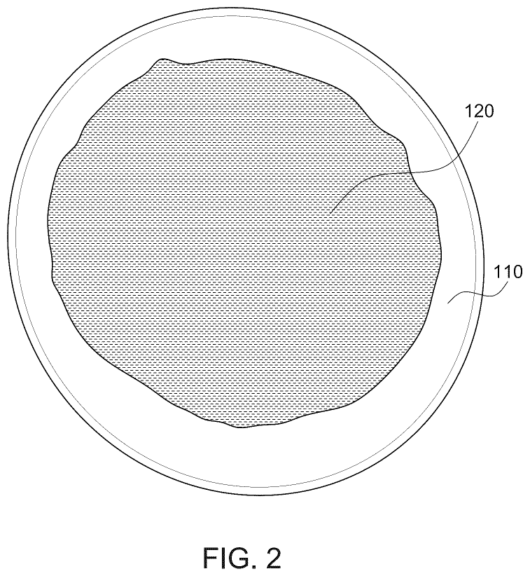

Referring to FIG. 2, a first view of the meltable cheese and sauce combination product is shown.

In this view, the second cheese slice 112, or lower cheese slice, is partially covered with sauce mixture 120, but first cheese slice 110 (see FIG. 1) has not yet been applied.

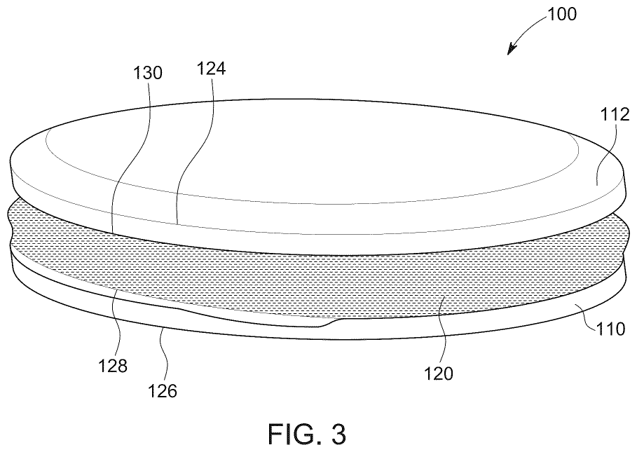

Referring to FIG. 3, a second isometric view of the meltable cheese and sauce combination product is shown.

As in FIG. 1, the meltable cheese and sauce combination product 100 is shown in its assembled state, with first cheese slice 110 and second cheese slice 112 substantially surrounding the sauce mixture 120. But in this figure, the sauce layer 120 is more substantial. To assemble versions such as this, the sauce layer 120 is optionally allowed to solidify inside of a form with sides, and a disk-shape is cut out for application to the second cheese slice 112. Or alternatively, the components are layered inside of a pan with a cylindrical depression, the pan preventing the sauce from spreading out beyond the second cheese slice 112.

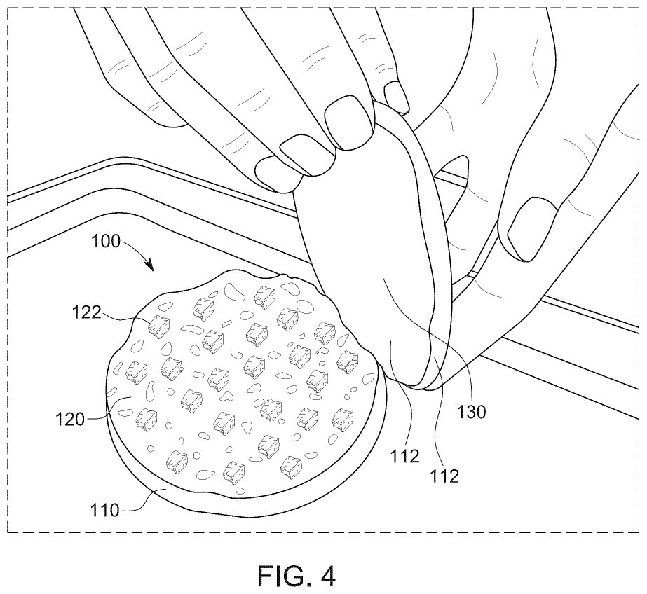

Referring to FIG. 4, a view during assembly of the meltable cheese and sauce combination product is shown.

In this version the sauce mixture 120 includes meat particles 122. The resulting combination mixture is placed between the first cheese slice 110 and the second cheese slice 112.

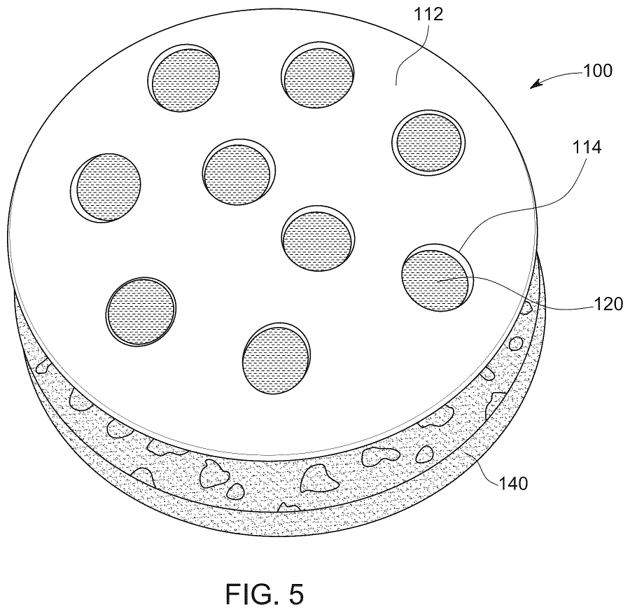

Referring to FIG. 5, a view showing upper holes, before heating, of the meltable cheese and sauce combination product is shown.

The meltable cheese and sauce combination product 100 is shown with upper holes 114 in the second cheese slice 112. The combination is placed on top of a bread product 140, such as an English muffin, in preparation for heating.

The bread product 140 such as a pizza base, a bagel, a bun, a bread substrate, a meat substrate, a vegan base, and the like may be anticipated by the present invention. The bread product 140 may encapsulate the meltable cheese and sauce combination product 100. The meltable cheese and sauce combination product 100 may be wrapped into the bread product 140. The meltable cheese and sauce combination product 100 may be sandwiched between two or more products such as the bread product 140. The bread product 140 may be broken down to insert the meltable cheese and sauce combination product 100. The meltable cheese and sauce combination product 100 may be heating independently and applied to the bread product 140.

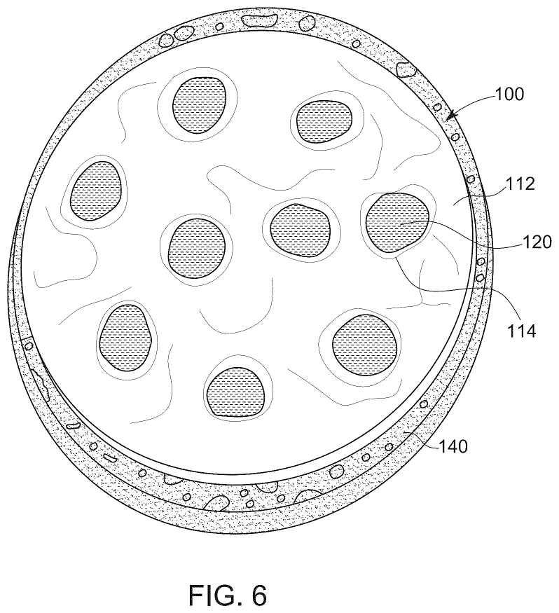

Referring to FIG. 6, a view showing upper holes, after heating, of the meltable cheese and sauce combination product is shown.

The meltable cheese and sauce combination product 100 has been heated, causing the second cheese slice 112 to melt, and the sauce mixture 120 to pass through the upper holes 114. The meltable cheese and sauce combination product has also fused with the bread product 140.

The fusion is a result of heating. As the first cheese slice 110 melts due to heating, the lower face 116 of the sauce mixture 120 fuses with the first cheese slice 110 (see FIG. 1). As the second cheese slice 112 melts due to heating, the upper face 118 of the sauce mixture 120 fuses with the second cheese slice 112. The heating melts the first slice of cheese 110 and the second slice of cheese 112, which makes then stick to the bread product 140 as well. The heating can be applied through any means known in the art that can be used for cooking food items.

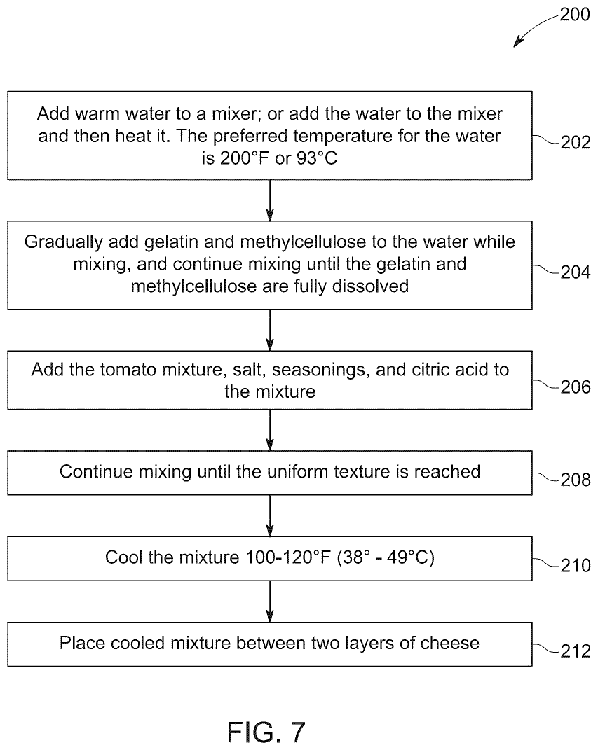

FIG. 7 is a flow chart depicting one method of making the meltable cheese and sauce combination product.

The method 200 is shown divided into steps.

In the water adding step 202, warm water is added to a mixer, or water is added to the mixer and then heated.

In the gelatin adding and mixing step 204, gelatin and methylcellulose are gradually added to the water while the water is mixed, mixing continuing until the gelatin and methylcellulose are fully dissolved.

In the tomato and seasoning adding step 206, the tomato mixture, salt, seasonings, and citric acid are added to the mixture.

In the mixing step 208, mixing of the ingredients continues until the texture is uniform-no lumps or other collections of ingredients.

In the cooling step 210, the mixture is cooled to 100-120° F. (38°-49° C.), where it will thicken in preparation for assembly.

In the assembly step 212, the tomato mixture is combined with cheese slices to create the final product.

Equivalent elements can be substituted for the ones set forth above such that they perform in substantially the same manner in substantially the same way for achieving substantially the same result.

1. A food product comprising:
a sauce disk and cheese disk that is flexible and self-supporting at room temperature;
the sauce disk and cheese disk formed from a combination of:
a first slice of cheese placed against a lower face of a sauce disk;
a second slice of cheese placed against an upper face of the sauce disk;
the second slice of cheese including two or more holes through which sauce of the sauce disk will pass when heated;
whereby the second slice of cheese prevents contact between a user's hand and the sauce disk; and
wherein the two or more holes in the second slice of cheese allow sauce to pass through the second slice of cheese during heating.

2. The food product of claim 1, wherein the sauce disk comprises water, tomatoes, gelatin, methylcellulose, and seasoning.

3. The food product of claim 1, wherein the sauce disk comprises:
water content of from about 30-60%;
tomatoes content of from about 40-70%;
gelatin content of from about 0.5-3%;
methylcellulose content of from about 0.2-1%;
spices, including salt content of from about 0-3%; and
citric acid content of from about 0-1%;
wherein all percentages are by weight and are based upon a weight of the sauce disk and cheese disk taken as 100% by weight.

4. The food product of claim 1, wherein the sauce disk further comprises meat.

5. The food product of claim 4, wherein the meat is selected from the group consisting of sausage and pepperoni.

6. The food product of claim 1, wherein the first slice of cheese and second slice of cheese are circular precut mozzarella slices with a diameter of approximately 3.5 inches and a thickness of approximately 2.53 mm.

7. A method of preparing a cheese-sauce-cheese combination product, the method comprising:
preparing a sauce by mixing water, tomatoes, gelatin, methylcellulose, spices including salt, and citric acid;
depositing the sauce onto a first precut slice of mozzarella cheese;
placing a second precut slice of mozzarella cheese on top of the sauce; and
fusing the first precut slice of mozzarella cheese, sauce, and second precut slice of mozzarella cheese together to form the cheese-sauce-cheese combination product;
wherein the mozzarella cheese comprises 56% by weight of the cheese-sauce-cheese combination product and the sauce comprises 44% by weight of the cheese-sauce-cheese combination product.

8. The method of preparing a cheese-sauce-cheese combination product of claim 7, further comprising the steps of:
placing the cheese-sauce-cheese combination product on a bread product to create a pizza product;
heating the pizza product, causing the first precut slice of mozzarella cheese and the second precut slice of mozzarella cheese to melt, and causing the sauce to soften and liquify.

9. The method of preparing a cheese-sauce-cheese combination product of claim 7, wherein the sauce further comprises meat.

10. The method of preparing a cheese-sauce-cheese combination product of claim 9, wherein the meat is selected from the group consisting of sausage and pepperoni.

11. The method of preparing a cheese-sauce-cheese combination product of claim 7, wherein the sauce comprises, by weight percentage:
30% to 60% water;
40% to 70% tomatoes;
0.5% to 3% gelatin;
0.2% to 1% methylcellulose;
0 to 3% spices, including salt; and
0 to 1% citric acid.

12. The method of preparing a cheese-sauce-cheese combination product of claim 7, wherein second precut slice of cheese further comprises two or more holes;
the two or more holes allowing the sauce layer to melt through the second slice of cheese when meltable cheese and sauce combination product is heated.

13. A food product that is flexible and self-supporting until heated, the food product comprising:
a first layer of cheese, wherein the first layer of cheese includes a first cheese in a first preset proportion;
a tomato-based sauce, wherein the tomato-based sauce comprises:
a gelling agent to keep the tomato-based sauce firm until heated; and
a tomato, vegetables, meat and spices combination in a second preset proportion;
a second layer of cheese, wherein the second layer of cheese comprises:
a second cheese in a third preset proportion, and
a plurality of holes;
wherein, the tomato-based sauce is placed between the first layer of cheese and the second layer of cheese, and a first surface of the tomato-based sauce is in contact with the first layer of cheese and a second surface of the tomato-based sauce is in contact with the second layer of cheese and the tomato-based sauce melts through the plurality of holes when the food product is heated.

14. The food product as claimed in claim 13, wherein the tomato-based sauce includes the meat selected from a group consisting of sausage and pepperoni.

15. The food product as claimed in claim 13, wherein the tomato-based sauce portion comprises, by weight percentage:
39.55% water,
56.80% tomatoes,
2.47% gelatin,
0.48% methylcellulose,
0.70% spices including salt, and
0.02% citric acid.

16. The food product as claimed in claim 13, wherein the first layer of cheese and the second layer of cheese are circular precut mozzarella slices with a diameter of approximately 3.5 inches and a thickness of approximately 2.53 mm.

17. The food product as claimed in claim 13, wherein the first layer of cheese and the second layer of cheese together comprise about 56% by weight of the total food product and the tomato-based sauce comprises about 44% by weight of the food product.

18. The food product as claimed in claim 13, wherein the first surface of the tomato-based sauce is bound to the first layer of cheese until heated.

19. The food product as claimed in claim 13, wherein the second surface of the tomato-based sauce passes through the plurality of holes when the food product is heated.

20. The food product as claimed in claim 16, wherein:
a top side of the first layer of cheese is in contact with the tomato-based sauce;
a bottom side of the first layer of cheese is in contact with a first bread substrate;
a top side of the second layer of cheese is optionally in contact with a second bread substrate; and
a bottom side of the second layer of cheese is in contact with the tomato-based sauce.

21. The food product as claimed in claim 13, wherein a combination of gelatin and methyl cellulose is used as the gelling agent to keep the tomato-based sauce firm until heated.

22. The food product as claimed in claim 21, wherein the combination of gelatin and methyl cellulose controls viscosity of the tomato-based sauce to ensure an even distribution of sauce through the plurality of holes of the second layer of cheese on application of heat.
